(19) United States
(12) Patent Application Publication
(10) Pub. No.: US 2015/0260168 A1
(43) Pub. Date: Sep. 17, 2015

(54) PROPULSION DEVICE FOR TRANSMITTING MOMENTUM

(71) Applicant: EUROPEAN AERONAUTIC DEFENCE AND SPACE COMPANY EADS FRANCE, Paris (FR)

(72) Inventor: Jean-Francois Geneste, Toulouse (FR)

(21) Appl. No.: 14/439,005

(22) PCT Filed: Oct. 22, 2013
(86) PCT No.: PCT/EP2013/072027

§ 371 Date: Apr. 28, 2015

(30) Foreign Application Priority Data
Oct. 31, 2012 (FR) 1260441

(51) Int. Cl. F03G 7/06; H02K 7/02; F03G 3/00; H02K 41/02

(52) U.S. Cl. CPC F03G 7/06; H02K 41/02; H02K 7/02; F03G 3/00

(57) ABSTRACT

A propulsion device for exerting a propulsive force on a vehicle generates an impulse of momentum by a piston of non-zero mass, an acceleration produced by a force acting on a structure of the vehicle and the braking produced in isolation inside the propulsion device without any force being applied to the vehicle. The piston moves inside a cross-shaped cavity from a reference position to an end of a cylindrical part of the cavity where it is stopped by a gas that it compresses adiabatically. The cross-shaped cavity is rotated by a quarter turn before the piston is released to return to the reference position. The propulsion device can comprise two cross-shaped cavities rotating in opposite directions.

This invention belongs to the field of propulsion devices wherein a momentum is generated to create a propulsive force.

More particularly, the invention relates to a vehicle propulsion device wherein the momentum is created without any ejection of matter.

More particularly, the propulsion device in question is a vehicle for manned or unmanned interplanetary or interstellar voyages.

In the propulsion field, it is known, particularly though not exclusively for space applications, to create a propulsive force in a vehicle by imparting a speed to a quantity of matter on board the vehicle and by ejecting this matter.

In a known manner, in a vehicle forming an isolated system characterized by its mass m0 and its speed V0, the momentum of a mass dm ejected at the speed ve is expressed by the product ve.dm of the ejected mass times the ejection speed measured relative to the vehicle.

Due to the conservation of momentum, the speed of the vehicle is modified by a value dV0 according to the known equation:

m0·dV0=ve·dm.

When a mass is ejected continuously at an output dm/dt=ρ, the preceding equation may be written as follows:

ρ·ve·dt=m0·dV0

hence the following thrust generated by the propulsion system:

ρ·ve=m0·dV0/dt

In a land or atmospheric vehicle that is propelled by reaction, the continuous ejection of mass does not pose any insurmountable problem, the mass to be ejected being drawn from the ambient medium, air or water, and accelerated inside the vehicle in order to be ejected after having acquired a momentum.

In the case of self-propelled vehicles unable to benefit from the capability to draw the mass to be ejected from the ambient medium, as in the case of rocket engine propulsion and in the case of propulsion in space, it is necessary to carry the mass to be ejected on board the vehicle for the entire duration of operation of the propulsion system.

Despite this constraint, space vehicles are currently propelled according to this principle.

To create a given propulsive thrust, it is possible to use a high output and a low ejection speed or a low output and a high ejection speed, and it is generally this second tendency that is used for space vehicles.

But even in that case, as revealed by a simple calculation of the order of magnitude of the mass that must be ejected during the operation of a propulsion system according to this principle, the constraints appear to be practically insurmountable in the case of long interstellar voyages requiring high speeds to be acquired in order to be completed within an acceptable time frame.

The ejection speed is limited according to the general theory of relativity to the speed of light in a vacuum, i.e. c=3*10E8 m/s.

A known plasma engine ejects accelerated ions at speeds similar to the speed of light. With an output for example of 2 mg/s, which currently can conceivably be achieved in an onboard installation, a thrust of 100 mN is obtained for an onboard electric power consumption on the order of 1.5 kW.

In order to obtain such a thrust for one year, a total mass of 63,000 Kg would be ejected, which in this case would enable a vehicle weighing 100,000 Kg, i.e. less than twice the ejected mass, to reach a speed of only 5 Km/s (compared, for example, to the escape velocity of 11 Km/s required merely to overcome the force of gravity).

It is clear that such a high consumption of matter for a result that remains far from what is needed for an interstellar voyage is unacceptable.

In order to overcome this problem, it has been considered to use a photon flow, for example the flow radiating from a black body oriented as in the device described in the patent application FR 2795457.

However, while such a device eliminates the ejection of mass through the use of radiation pressure, the thrust forces obtained are weak relative to the dimensions of the propulsion device.

The propulsion device of the invention for exerting a propulsive force on a vehicle works by momentum exchange.

In the propulsion device, the momentum is obtained by the movement of at least one piston of non-zero mass, an acceleration of which is produced by a force acting on a structure of the vehicle and the braking of which is produced in isolation inside the propulsion device without any force being applied to the vehicle.

Thus, the transfer of momentum to the carrying vehicle is obtained along an axis of acceleration of the piston, tending to move the vehicle in the opposite direction from the movement of the piston, without any matter being ejected in order to obtain the desired momentum.

The propulsion device comprises at least one cavity comprising one or more cylindrical parts, inside which cylindrical part or parts the piston associated with a cavity is movable, each cylindrical part inside which the piston is capable of moving comprising a device that absorbs a kinetic energy of the piston so as to brake the piston in isolation inside the propulsion device.

The cylindrical parts, of circular or other cross-section, thus guide and support the piston so that the piston is actually brought to the energy absorbing device so as to be braked without any exchange of energy with the outside of the propulsion device.

In one embodiment, the cavity is sealed and contains a gas, and the piston is movable inside the cylindrical part or parts of the cavity in a sealed fashion so that the gas located in a cylindrical part on one side of the piston does not flow between the piston and a wall of the cylindrical part to an opposite side of the piston. When the piston is moved inside a cylindrical part as a result of an impulse of momentum, it determines two zones of this cylindrical part with no exchange of gas, particularly in the presence of a different gas pressure on the two sides of the piston. In this embodiment, the kinetic energy of the piston is absorbed by the compression of the gas between a face of the piston and the end of the cylindrical part toward which the piston is moved, the isolation of the system resulting from a condition in which the compression is produced substantially adiabatically.

In the propulsion device, a cylindrical part of a cavity inside which the piston must be moved has a first orientation of a longitudinal axis of said cylindrical part, corresponding to a direction in which it is desired to create a propulsive force when the piston is accelerated from a reference position of the cavity, and has a second orientation, different from the first orientation, when the piston is returned to the reference position of the cavity.

Thus, the momentum produced when the piston, returned to the reference position, must be stopped in this reference position is not exerted in the opposite direction from the momentum produced during the prior acceleration, and therefore does not cancel out the effects of the latter, which would have been the case if the orientation of the cavity had not been modified.

When the piston is accelerated from the reference position of the cavity, it compresses the gas contained in the cylindrical part of the cavity between the piston and the closed end of this cylindrical part, this compression being adiabatic or at least substantially adiabatic, and the piston is returned to the reference position of the cavity under the effect of the pressure of the compressed gas in the cylindrical part of the cavity acting on the piston, without any intake of energy from the outside.

In order to immobilize the piston during the time required to change the desired orientation of the cylindrical part in which the piston having compressed the gas is located, preferably each cylindrical part of a cavity in which a piston compresses or is capable of compressing the gas, comprises at least one piston lock capable of keeping the piston immobile inside the cylindrical part when the gas is compressed.

In one embodiment, the piston or pistons are made from a magnetic material and each piston is accelerated, from the reference position of the cavity in which it is movable, by means of an electromagnet located, at least temporarily, near the end of the cylindrical part of the cavity in which the core is accelerated.

To guarantee a satisfactory acceleration of the piston in the case of cylindrical parts of substantial length relative to the magnetic field created by the electromagnet, one or more intermediate electromagnets are disposed, if necessary, between the reference position and the electromagnet located near the end of the cylindrical part.

It is thus possible to impart an impulse of momentum to the piston using completely controllable electromagnetic means, while limiting the number of moving parts of the device.

In one embodiment, the propulsion device comprises at least one cross-shaped cavity formed by two elementary cylindrical cavities with longitudinal axes oriented at right angles so as to form a cross comprising four cylindrical parts forming branches of the cross, determining at an intersection of these elementary cavities the reference point of the cavity.

The propulsion device also comprises, in this configuration of the cavity, a system for driving the cross-shaped cavity in rotation by quarter-turns, in the plane of the cross around an axis passing through the center of the cross, which enables the cavity to be rotated by a 90-degree angle after the piston has been accelerated from the reference position of the cavity in which it is movable in order to produce a momentum and before this piston is returned to the reference position of the cavity. Thus, the modification of the orientation of the cylindrical part in which the piston is located is easily modified and makes it possible, when the piston is returned to the reference point, to return the cavity to a configuration equivalent to the one from which the piston was moved in order to generate a propulsive momentum during a previous cycle.

In order to eliminate or at least reduce the angular momentum induced by the rotation of a cross-shaped cavity, the propulsion device preferably comprises at least two cross-shaped cavities disposed relative to each other so as to be driven in rotation separately. In this case, the rotational drive system of the cavities drives the cavities in rotation in opposite directions and in synchronized fashion so as to minimize an angular momentum resulting from the rotational movements. To obtain the desired result, the cross-shaped cavities are disposed in parallel planes and are centered on a common axis perpendicular to the planes of the crosses.

In an alternative embodiment of the propulsion device, the device comprises at least one cylindrical cavity in which the piston determines a substantially empty volume between the piston and a first end of the cavity, which end corresponds to the reference position of the piston inside the cavity, and a volume containing the gas between the piston and a second end of the cavity, and comprises a rotational drive system for the cylindrical cavity such that the cylindrical cavity can be rotated by a 180-degree angle so as to reverse the orientation of a longitudinal axis of the cylindrical cavity, after the piston (20, 20′) has been accelerated from the reference position of the cavity (10, 10′) in which it is movable in order to produce a momentum and before said piston is returned to said reference position of said cavity.

In this cylindrical cavity embodiment, the propulsion device preferably comprises at least two cylindrical cavities embodied so as to enable separate rotations of each of the cavities in parallel planes, and the rotational drive system is embodied so that the two cavities can each be rotated by a 180-degree angle, in opposite directions and in synchronized fashion, so as to minimize the angular momentum resulting from the rotational movements.

In one embodiment, the drive system is capable of reversing the rotational direction of the cavities.

It is thus possible to reduce the effects of manufacturing tolerances which may result in moments of inertia and angular momenta that are different in absolute value between the different cavities.

The reversals in the directions of rotation are for example produced periodically, every n cycles, n possibly being equal to 1, or as a function of measured angular accelerations or deviations.

In order to further reduce the effects of differences in angular momenta, the propulsion device comprises for example a flywheel capable of compensating for the moment of inertia created by the changes of the direction of one or more cylindrical parts of cavities.

The correction of the effects of these tolerances on the angular momenta is performed, if necessary in concert with other means, by a moment of inertia correction device operating on the basic principal of the propulsion device.

The correction device comprises a sealed cylindrical cavity having a longitudinal axis and containing a gas between a magnetic piston and an end of the cylindrical cavity near which is placed an electromagnet disposed so as to exert an attractive force on the piston and to compress the gas contained in the cavity. The correction device also comprises a heat exchanger for supplying, or extracting from the gas contained in the cavity, energy in the form of heat. The correction device is attached to a structure of the vehicle carrying the propulsion device so as to create a torque for correcting the angular momentum induced by the propulsion device.

Thus, using a correction device wherein the compression/expansion cycle of the gas is not adiabatic, a force is created along the longitudinal axis of the correction device, the orientation of which makes it possible to create a control torque, which is produced without any ejection of matter.

This invention is described in reference to the figures which, in a nonlimiting way, schematically represent:

FIG. 1: a propulsion device of the invention with a cross-shaped cavity with four branches;

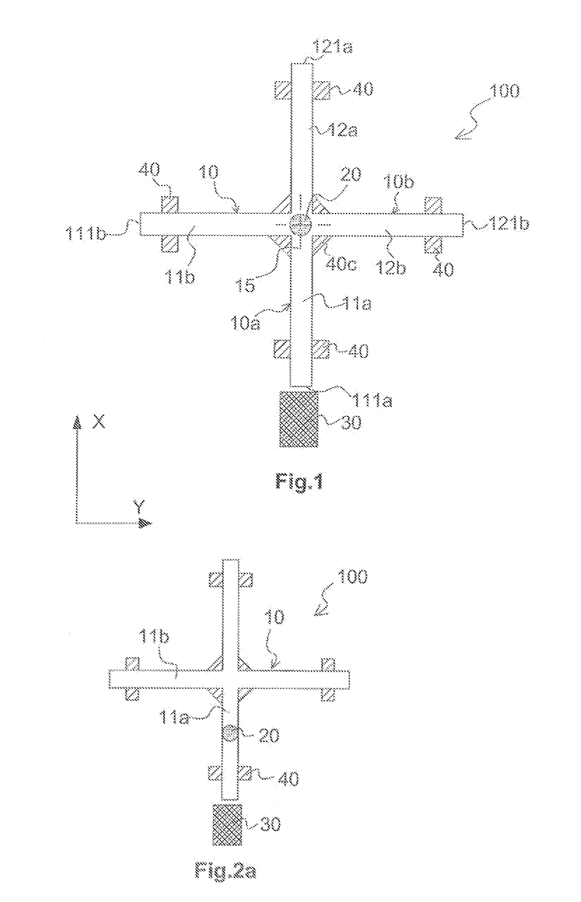

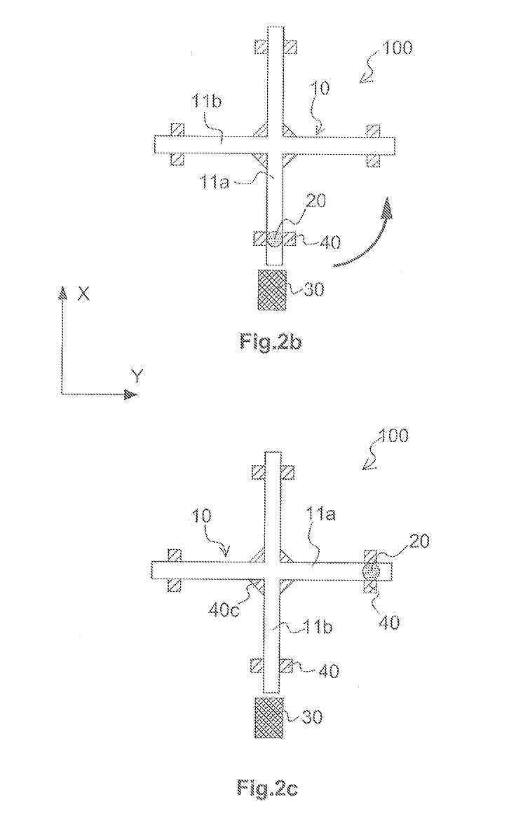

FIGS. 2a, 2b and 2c: the propulsion device of FIG. 1 in the successive phases of an operating cycle;

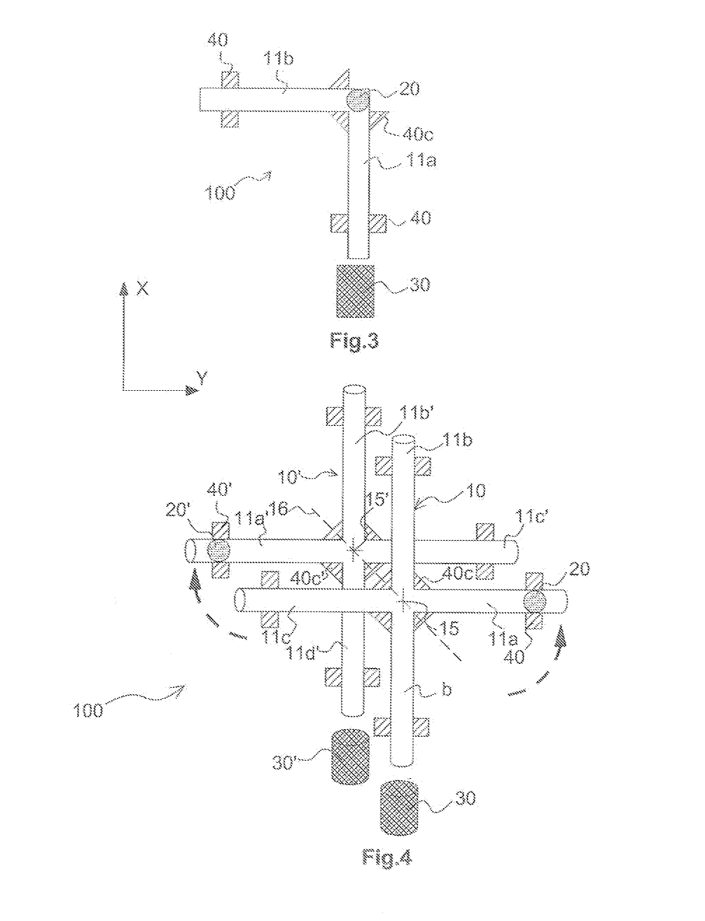

FIG. 3: a propulsion device comprising a cavity with two branches;

FIG. 4: a representation in axonometric perspective of a propulsion device with two cross-shaped cavities;

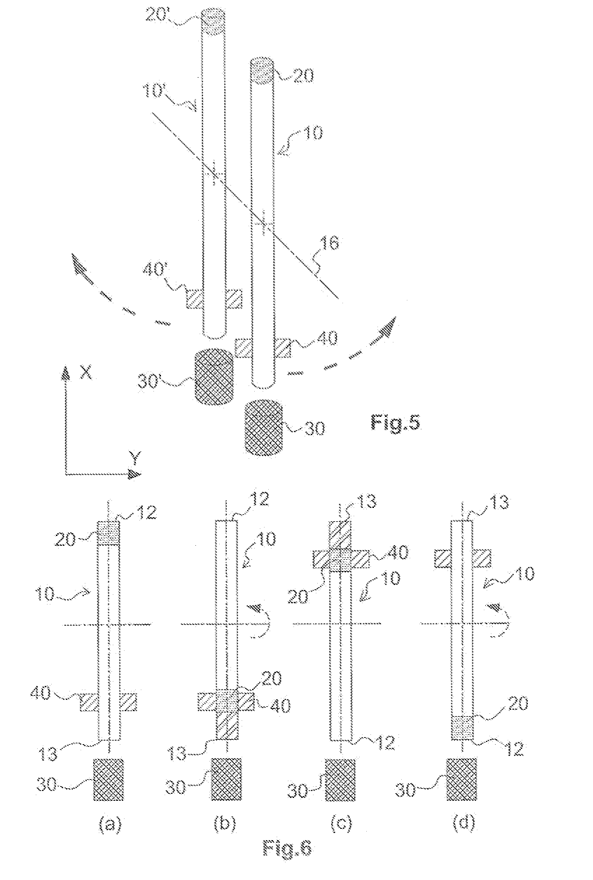

FIG. 5: a propulsion device with two cylindrical cavities;

FIG. 6: a representation illustrating, in the case of a cylindrical cavity of

FIG. 5, the successive phases of an operating cycle of the propulsion device with two cylindrical cavities; and

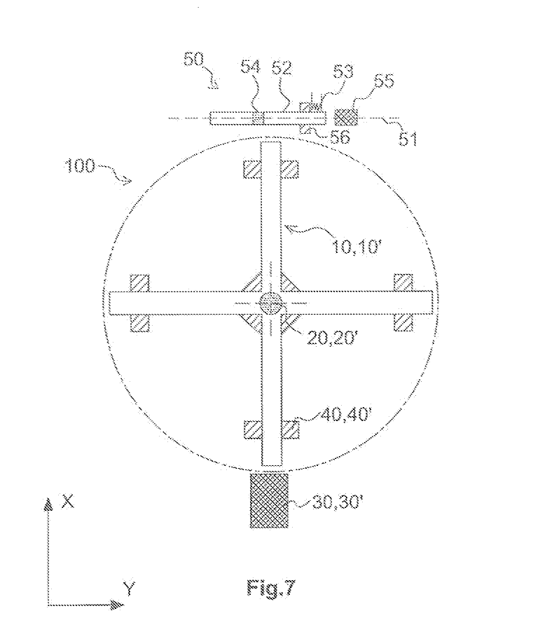

FIG. 7: the propulsion device of FIG. 4, seen along the axis of rotation of the cavities, comprising an angular momentum correction device.

The figures are schematic illustrations of the principles implemented by the invention without concern for the dimensions or scale of the various components of the propulsion device.

The figures do not provide any details on the embodiment of the ordinary means that would need to be implemented in order for the propulsion device to function.

It should also be noted that for the sake of clarity in the explanations, the hypothetical cases considered will be implicitly or explicitly simplified such that certain disturbance phenomena will be omitted in at least some cases.

For example, it may be presumed that the gases used in the invention are perfect gases, that the friction is negligible, that the piston does not leak, or that the operation is adiabatic.

For purposes of simplification, extensive use will also be made of the term “cavity,” which depending on the context will be understood to designate the volume forming the cavity itself, or the surface delimiting the cavity, or an undescribed structure in which the volume of the cavity is produced, or even the cavity plus the piston it contains, the electromagnet associated with it, and in general all of the equipment associated with it.

FIG. 1 illustrates an example of the principles of a first embodiment of a propulsion device 100 according to the invention.

The propulsion device 100 comprises a cavity 10, a piston 20, an electromagnet 30, and piston locks 40, 40c.

The cavity 10, only one internal wall of which is shown in the figures, is a cross-shaped cavity formed by two elementary cylindrical cavities 10a, 10b intersecting at a substantially right angle at their centers and determining a cross having four branches 11a, 12a, 11b, 12b, theoretically of equal length L.

Each branch 11a, 12a, 11b, 12b is closed at its end, respectively 111a, 121a, 111b, 121b, opposite a center 15 of the cross, which in the case of the cross-shaped cavity is used as a reference position.

The cavity 10 encloses a gas in an internal volume of said cavity delimited by the wall of the cylindrical parts and by the ends of the branches of the cavity 10.

The wall of the cavity is impermeable to the gas contained in the internal volume, as are the closures of the ends of the branches.

The cavity 10 is rotatably mounted around an axis passing through the center 15 of the cross and orthogonal to a plane of the cross defined by the directions of the two elementary cavities 10a, 10b. The rotation of the cavity around said axis is produced by means of actuators of a rotational drive system, not represented, whose functions will be included in the description of the operation of the propulsion device.

The piston 20 is inside the cavity 10. Moreover, the dimensions and the shape of the piston 20 are such that the piston is free to move inside the cavity 10 along all four branches of said cavity, from the reference position in the center 15 of the cross toward each of the ends 111a, 121a, 111b, 121b of the branches of said cross, thus ensuring a seal between said piston 20 and the wall inside the cylindrical parts.

For practical reasons, each branch of the cavity 10 is of circular cross-section and the piston is a sphere.

However, the choice of a circular cross-section is not mandatory, and the cylindrical parts may have other cross-sectional shapes, such as for example a square cross-section, as long as the piston itself has an appropriate shape, which in the case of a cylinder of square cross-section is advantageously cubical.

The diameter of the sphere is chosen so as to obtain between the surface of the sphere and the wall of the cylindrical parts a gap that is smaller than the mean free path of the molecules of the gas contained in the cavity.

Furthermore, when the piston 20 is in the reference position at the center 15 of the cross, each branch contains an equal quantity of gas, or at least has an equal gas pressure, so that the center position is a balanced position of the piston without the application of external forces. This condition is obtained with no problem due to the fact that in the center position of the piston it is not necessary for the seal of the piston 20 to be maintained and the volumes of the different branches 11a, 12a, 11b, 12b can communicate so that the pressure of the gas in said different branches is naturally balanced.

The piston 20 is made from a magnetic material.

In one embodiment, the electromagnet 30 is located at a distance from the center 15 of the cross slightly longer than the length L of each branch of said cross.

The electromagnet is offset relative to the center of the cross in the direction of a longitudinal axis X of a reference frame of a vehicle, not represented, carrying the propulsion device 100.

The electromagnet 30 is disposed so as to create a magnetic field oriented in the direction of the longitudinal axis X.

In the configuration described, the activation of the electromagnet 30 creates a magnetic field which, through its action on the piston 20 made of magnetic material, creates a force F tending to draw said piston toward said electromagnet.

In a non-illustrated embodiment, one or more intermediate electromagnets are distributed along the length of the branch between the center of the cross 15 and the electromagnet 30 located near the end of the branch in question. In this case, the intermediate electromagnets are disposed so as to generate a magnetic field oriented along the axis of the branch in question.

The piston locks 40, 40c consist in any device that can immobilize the piston 20 inside the cavity 10.

Such means may for example consist in mechanical devices in which pins inside the cavity oppose the movement of the piston.

Such means can also consist in coils for confining the piston 20 made of magnetic material to a desired zone.

The device comprises at least one piston lock 40 on each of the branches 11a, 12a, 11b, 12b of the cavity, located between the center 15 of the cross and the end 111a, 121a, 111b, 121b of the corresponding branch, theoretically offset toward said ends of the branches.

Advantageously, the propulsion device 100 also comprises one or more piston locks 40c for immobilizing the piston in the center part of the cross common to the two elementary cavities 10a, 10b.

The propulsion device of FIG. 1 therefore operates according to the following sequence, the various phases of which are illustrated in FIGS. 1, 2a, 2b and 2c.

In a first phase, corresponding to a balanced position illustrated in FIG. 1, the electromagnet is not activated, the cavity 10 is locked in rotation, with one of the elementary cavities, 10a in the example illustrated, having a longitudinal axis of said elementary cavity parallel to the longitudinal direction X.

The other elementary cavity, 10b in the example illustrated, is therefore oriented with a longitudinal axis of said cavity in a perpendicular direction, parallel to a transverse axis Y of the reference frame of the carrying vehicle.

The piston 20 is located in the cavity 10 at the center 15 of the cross formed by the elementary cavities 10a, 10b, and the gas inside the cavity 10 has the same pressure in each of the branches of the cross.

In a second phase, the electromagnet is activated, and the piston 20 moves, FIG. 2a, toward the end 111a of the branch 11a located near the electromagnet 30 under the effect of the magnetic field produced by said electromagnet.

In the embodiment comprising one or more intermediate electromagnets, each electromagnet is activated as a function of the position of the piston 20 so as to exert on said piston a force oriented in the direction of the end of the branch of the cross in which the piston is moving. The activation of the intermediate electromagnets in this case is similar to the operating mode of a linear electric motor, or in the context of electric fields, to that of a linear particle accelerator.

This configuration is for ensuring, particularly in the case of cylindrical cavities of substantial length, an efficient acceleration of the piston that an electromagnet alone would have difficulty creating.

In this movement of the piston 20, said piston compresses the gas contained in the part of the cavity 10 located in the branch inside which the piston is moving, between the piston 20 and the end 111a located near the electromagnet 30, whereas the pressure of the gas is reduced in the rest of said cavity because of the seal of the piston with the wall of the cavity.

The movement of the piston 20 continues until the differential pressure of the gas on each side of the piston balances the force F with which the piston is attracted by the electromagnet 30, and the piston stops its movement when this balance is reached, it being assumed that the magnetic field created by the electromagnet is maintained, and/or that the piston lock 40 of the branch in question stops said piston accelerated, in this case, by an impulse.

When the piston 20 is immobilized, its position near the end of the branch near the electromagnet is locked by the piston lock so that the piston does not return to the center 15 of the cross under the effect of the pressure exerted by the compressed gas when the electromagnet is deactivated.

In this second phase, the electromagnet 30 has imparted to the piston 10, which has a mass, an energy which initiates the movement of said piston, the momentum whereof will be transmitted to the vehicle to which the electromagnet 30 and the cavity 10 are connected due to the conservation of total momentum.

Conversely, the cavity 10 and the gas it encloses form, with the piston 20, an isolated system.

When the piston 10 slows down and stops under the effect of the pressures exerted by the gas in the branch in which said piston is moving, this stopping of the piston takes place without any exchange of energy with the outside, at least in the case where the compression is adiabatic.

The stopping of the piston therefore will not have the opposite effect, in terms of momentum, on the carrying vehicle, of the initial movement created with the electromagnet 30.

In a third phase, illustrated in FIG. 2b and FIG. 2c, the sphere is locked in the position reached at the end of the second phase, FIG. 2b, and the rotational drive system of the cavity is activated so as to rotate the cross-shaped cavity in its plane around the center 15 by a 90-degree angle, FIG. 2c, so that the longitudinal axis of the elementary cavity 10a, initially oriented in the longitudinal direction X, is then oriented in the transverse direction Y, the other elementary cavity 10b, oriented in the transverse direction Y in the preceding phase, being re-oriented in the longitudinal direction X.

The piston 20 in this phase is always locked.

In a fourth phase, the piston lock 40 maintaining the piston 20 in place is released so that said piston, subjected to the pressure of the compressed gas in the branch, is pushed toward the center 15 of the cross.

When the piston 20 reaches this point, the piston locks 40c placed at the center of the cross then stop the piston so as to immobilize it in the center position and to return to a configuration identical to that of FIG. 1 but with the cavity having rotated 90 degrees.

During this fourth phase, the locking of the piston 20 in the center 15 of the cross restores the momentum initially imparted to the piston by the electromagnet, but given the rotation of the cross produced during the third phase, this momentum is oriented in the transverse direction Y, i.e. at 90 degrees from the initial direction X.

The advantage of the desired movement in the longitudinal direction X is therefore not lost.

A new activation cycle of the electromagnet can then be initiated so that the new impulse of momentum of the piston is combined with the previous impulse or impulses.

This first embodiment is subject to variants.

For example, it is possible to create a cavity comprising only two branches at right angles like the cavity illustrated in FIG. 3, for example the branches 11a and 11b, which are used in the cycle described and are necessary for the following cycle. In this case, 90-degree rotations must be produced from one cycle to the next during the third phase, alternately in one direction and then in the other direction so as to always obtain, after said 90-degree rotation, a branch oriented in the longitudinal direction X whose end is near the electromagnet so as to be in the correct configuration for performing a new cycle.

For example, it is possible to consider a cross-shaped cavity empty of gas wherein each end of the cross comprises a device for damping the piston, for example a spring, which absorbs the kinetic energy of the piston so that the cavity and the piston still form, as in the case of the compression of a gas, an isolated system. The kinetic energy is transformed into potential energy which can be restored in the form of kinetic energy by an impulse created by the spring when the piston lock releases said piston.

For example, it is possible to provide an electromagnet associated with each branch, with only the electromagnet of the branch in which the piston must be moved being activated at the desired moment.

In this case, it is possible to immobilize the piston near the end of a branch by means of the corresponding electromagnet, which continues to exert a force on the piston as long as it is activated, including during the rotation of the cavity. The electromagnet in this case, in addition to its nominal function of moving the piston, fulfills the function of a piston lock.

These embodiments can nonetheless generate drawbacks, for example an unbalancing of the rotating parts, the need to frequently reverse the direction of rotation of the cavities, moving electromagnets, etc., which must be compensated by specific devices. In these cases, a person skilled in the art would need to perform an assessment, taking into consideration the mass, volume, reliability and overall cost of the propulsion system to be produced, a normal process in systems design.

The first embodiment described above has, including in the case of the exemplary variants, a first drawback of creating a force oriented in the lateral direction Y when the piston is returned to its resting position.

This laterally oriented force has the effect of causing a curve in the trajectory of a ballistic vehicle. If care is taken during the third phase to alternately rotate the cavity by 90 degrees in opposite directions, each lateral impulse will have the opposite sign from the preceding one, resulting in an average force of zero in this lateral direction. It is therefore necessary to regularly reverse the direction of rotation, for example in each cycle, which may prove disadvantageous.

A second drawback is the creation of a torque around the axis of rotation due to the angular momentum induced by the rotation of the cross, this angular momentum being stronger the greater the mass of the piston, which will be sought in order to obtain a sufficient force generated by the propulsion system. Here again, additional stabilization devices may be used to compensate for these effects, but they may require a significant ejection of mass in a space vehicle, which runs counter to the solution sought by the invention.

In a second embodiment of the invention, illustrated in FIG. 4, the propulsion device comprises two independent cross-shaped cavities 10, 10′ produced according to the first embodiment described.

The independent cavities 10, 10′ are disposed so that their axes of rotation 16, passing through the centers 15, 15′ of the crosses, are the same.

An electromagnet 30, 30′ is associated with each cavity in similar fashion so as to produce, in each cavity, the movement of the piston 20, 20′ in the same direction.

In a variant of embodiment, the electromagnet is common to the two cavities. In the case where intermediate electromagnets are used, said intermediate electromagnets may, if necessary, also be common to the two cavities.

Each cavity functions according to the same cycle as in the example of the first embodiment.

Thus, during the second phase, each piston 20, 20′ is moved in the direction of the electromagnet 30, 30′ of the respective cavity 10, 10′ and the effects in terms of the momentum of the two pistons are cumulative.

During the third phase, the two cavities 10, 10′ are rotated by 90 degrees around their common axis of rotation 16, simultaneously but in opposite directions of rotation, the rotational drive system, not represented, being designed to produce these rotational movements.

Thus, if care has been taken to produce the cavities so that the rotating parts of said two cavities have identical moments of inertia, the cavities are theoretically identical, and this condition is met regardless of manufacturing tolerances, no disturbing angular momentum is created during the simultaneous rotation of the two cavities, at least in a perfect system.

During the fourth phase, given that at the end of the third phase the pistons 20, 20′ of each of the two cavities 10, 10′ are located, as in the illustration of FIG. 4, in symmetrical positions along the lateral direction Y relative to the axis of rotation 16 of the cavities, the forces induced by the return of the pistons 10, 10′ to the center position are of equal intensity but in opposite directions, and their resultant is therefore zero.

In this embodiment, no lateral thrust disturbing the trajectory of the vehicle is created.

In this case, it is therefore unnecessary, in theory, to reverse the direction of rotation of the cavities 10, 10′ which can be driven in rotation in a continuous or quasi-continuous movement.

This second embodiment, which is an improvement of the first embodiment described, is also subject to variants.

Some of these variants correspond to the same modified features presented in the first embodiment, and a person skilled in the art will have no problem identifying the described variants that apply to this second embodiment.

In one variant, not illustrated, the propulsion device comprises more than two cavities, always in even numbers, whose axes of rotation are the same. In this case, the propulsive effects of each cavity are combined with the effects of the other cavities without creating any lateral thrust.

This type of propulsion system architecture has the advantage of delivering different thrusts depending on the number of active cavities, or more precisely, pairs of active cavities.

A cavity in this case is considered to be inactive if it does not produce any thrust, which is obtained by not activating the corresponding electromagnet, regardless of whether the cavity is driven in rotation, in the case where only one active cavity is attached to a same rotating shaft.

It is also possible in this architecture to reconfigure the propulsion device in response to a failure causing one or more cavities to be rendered unusable, a reconfiguration which may result in the modification of the number of cavities in operation and their direction of rotation in order to restore a propulsion device producing a thrust under conditions similar to the second embodiment described.

Thus, it is possible to improve the reliability of the propulsion device and to maintain a thrust, albeit reduced, even in the event of failures.

It is also possible in this second embodiment not to have even numbers of identical cavities and/or pistons of equal mass.

For example, it is possible to produce only a first cavity associated with two second cavities disposed on the same axis of rotation but on either side of the first cavity and symmetrically. In this case, each second cavity is embodied such that the thrust it generates is half that of the first cavity and such that its moment of inertia is also half that of the first cavity.

The two second cavities are operationally coupled, and in terms of thrust and moment of inertia, are equivalent to the first cavity except in terms of the direction of rotation.

As a result of this arrangement, no torque is created around the longitudinal axis X during the return of the pistons to the central position during the last phase of a cycle.

Insofar as the two cavities of the second embodiment described above are necessarily offset in a direction perpendicular to the plane XY, as in the case of

FIG. 4, the forces in opposite directions resulting from the returns of the pistons to the center of their respective cavities are a source of disturbance torque. It is precisely this disturbance torque that is cancelled by the proposed three-cavity configuration.

FIG. 5 illustrates a third embodiment of a propulsion device 100 according to the invention.

According to this embodiment, the cavities are no longer cross-shaped but cylindrical.

A cylindrical cavity 10, 10′ in this embodiment corresponds to a branch of the cross-shaped cavity which is sealed at both of its ends.

The cylindrical cavity 10, also shown isolated in FIG. 6(a), encloses a piston 20, which in this case is not necessarily spherical and can be cylindrical, and an electromagnet 30 is disposed at one end of the cylindrical cavity.

The cylindrical cavity 10 has a length Lp and is sealed at both a first end 12 and a second end 13 of said cavity. The cavity 10 encloses a gas in a sealed fashion, and in a fashion similar to the preceding embodiments.

In this embodiment, unlike in the embodiment with one cross-shaped cavity, the piston 20 at rest is positioned in the reference position at the first end 12 of the cavity 10, the electromagnet 30 being in this position at the second end 13.

The gas contained in the cavity 10 is therefore located entirely, except for marginal quantities, on a same side of the piston 20, in the example illustrated between the piston 20 and the second end 13.

The electromagnet 30 is advantageously placed outside the cavity 10, which configuration makes it possible to avoid running feed wires of said electromagnet through the wall of said cavity, but said electromagnet could be disposed inside the cavity since its relative position with respect to said cavity when it is activated is always identical.

The other features of the cavity 10, the piston 20, the electromagnet 30, and if applicable, the piston lock 40 in this embodiment are similar to those of the embodiments described previously.

It should be noted that in this configuration, in which the speed of the piston is braked by the compression of the gas contained in the cavity, there is no longer any need to use a piston lock equivalent to the one in the center of the cross in the embodiment with one cross-shaped cavity. In essence, in the reference position of the piston, equivalent to the center position in the cross-shaped cavity, the piston rests against the first end 12 of the cylindrical cavity 10 and is held stable in that position by the pressure of the gas in the cavity.

As in the other embodiments, when the electromagnet is activated, the piston 20 moves, FIG. 6(b), in the direction of the electromagnet toward the second end 13.

In this movement of the piston 20, said piston compresses the gas contained in the cavity 10. In this embodiment, however, a vacuum is maintained, in the absence of any leaks and admission of external gas, between the piston 20 and the first end 12 due to the seal of the piston, the only major consequence of which is to increase the pressure difference between the two faces of the piston 20.

The movement of the piston 20 continues until the pressure of the gas that is compressed balances the force F with which the piston is attracted or accelerated by the electromagnet 30, and the piston stops its movement when this balance is achieved. The piston 20 can be maintained in this position by maintaining the activation of the electromagnet 30, and/or by activating the piston lock 40.

The result is of course the same as in the second phase of the embodiments described previously with respect to the momentum generated along the axis of the cylindrical cavity 10 and oriented in absolute value in the direction opposite the movement of the piston.

In the case of a cylindrical cavity 10, it is nevertheless not advantageous during the third phase to rotate the longitudinal axis of the cavity by a 90-degree angle because in this embodiment the return of the piston 20 to its initial position does not return the cavity+piston+electromagnet assembly to the configuration that makes it possible to create a new impulse of momentum in the longitudinal direction X.

In this embodiment, during the third phase, when the piston is locked in the position in which the gas is compressed, the propulsion device produces a 180-degree rotation of the cavity, which is then oriented in the direction opposite the initial direction along the longitudinal axis X as illustrated in FIG. 6(c).

In this position, during the fourth phase, the piston lock 40 is actuated so as to release the piston, which is pushed by the compressed gas. In this embodiment, the piston is not stopped in the reference position by the piston lock at the center of the cross-shaped cavity but more simply by the first end 12 of the cylindrical cavity 10, FIG. 6(d), and the stopping of the piston generates an impulse of momentum which is oriented in absolute value in the same direction as the impulse of momentum created during the second phase.

In this embodiment, a fifth phase is then implemented in which the cylindrical cavity 10 is again subjected to a 180-degree rotation so as to resume its initial position of FIG. 6(a) and is able to begin a new cycle.

Looking again at FIG. 5, we see that the propulsion device comprises two cylindrical cavities 10, 10′ like those of FIGS. 6(a) through 6(d), the operational details of which have just been described.

These two cavities are disposed in their initial positions with their longitudinal axes parallel to the longitudinal axis X and ready to perform the rotations provided in the third and fifth phases in parallel planes around a same axis of rotation 16.

Lastly, in order to avoid the disadvantages of an angular momentum created by the rotation of the cavities, the two cavities 10, 10′ are simultaneously rotated 180 degrees in opposite directions, as in the case of the propulsion device with two cross-shaped cavities with a 90-degree angle.

Although the configurations of the propulsion device comprising two or more cross-shaped cavities or two or more cylindrical cavities make it possible to compensate for the effects of the angular momentum created by the rotations of each of the cavities, such compensation cannot be perfect due to manufacturing tolerances, as a result of which the moment of inertia of the moving parts of each pair of cavities 10, 10′ cannot be mathematically identical.

Since the angular momentum resulting from the synchronized rotations of the moving parts cannot be strictly zero, the propulsion device preferably comprises a flywheel, not represented, connected to the propelled vehicle, which has an axis of rotation orthogonal to the plane of rotation of the cavities and which, according to established principles in the field of satellite stabilization, will compensate for the effects of the residual angular momenta of the propulsion device.

However, the speed of the flywheel will be accelerated as a result of the compensated angular momentum, risking the saturation of said flywheel. In that case, it is necessary to desaturate the flywheel, which according to the conventional methods is performed by nozzles with an ejection of matter.

In order to avoid an operation for desaturating said flywheel, and to thereby avoid such an ejection of matter, the directions of rotation of the cavities are periodically reversed, simultaneously of course in the case of an operationally coupled pair of cavities.

The reversal of the directions of rotation is for example performed periodically so that the residual angular momentum will be reversed and the flywheel will have a sinusoidal movement that will prevent a saturation of said flywheel.

The reversal of the directions of rotation is for example controlled based on sensors indicating a drift of the propelled vehicle or a limit reached by the flywheel.

In one embodiment, in order to perform a fine adjustment of the torque generated by the insufficiencies of inertial systems, the propulsion device 100 comprises a correction device 50 with a cylindrical cavity 52 according to the principles of the propulsion device of the invention, like the one represented in FIG. 6a or 6b, and comprising a piston 54 for compressing a gas contained in the cavity 52, an electromagnet 55 for actuating the piston and a piston lock 56 for immobilizing the piston in a controlled fashion.

The correction device 50 is embodied such that when said correction device creates a force, it generates a torque around the axis of rotation 16 of the cavities 10, 10′, be they cross-shaped cavities or cylindrical cavities, of the propulsion device 100.

As in the example illustrated in FIG. 7, such a result is obtained for example by providing the correction device 50 with a longitudinal axis 51, which is also the axis along which a force may be created, substantially tangent to a circle centered on the axis of rotation 16 of the cavities 10, 10′, in which the rotation of said cavities is inscribed.

A cylindrical cavity 52 of the correction device 50 is fixed in the reference frame of the carrying vehicle and thus the force it produces in adiabatic operation has a zero average force. In this case, in order to produce a non-zero average force, the operation of the correction device 50 is not adiabatic.

In the correction device 50, the gas is cooled or heated by means of a heat exchanger 53 during a cycle of a piston 54 and the momentum produced during the return of said piston to the resting position, during which the gas is expanded, is different from that produced during the compression of the gas.

Regulating the thermal energy exchanges of the correction device 50 controls a generated force and hence a torque around the axis of rotation 16 of the cavities 10, 10′ of the propulsion device 100, which makes it possible to precisely control a residual parasitic moment of inertia induced by said propulsion device, which parasitic moment of inertia would have the effect of causing a drift of a space vehicle.

In the exemplary embodiments, a piston is accelerated by means of a magnetic field generated by an electromagnet connected to the propelled vehicle, possibly connected to the cavity in which it produces its effects.

However, any means for imparting a sufficient initial speed to the piston for it to reach the desired position in which the piston will be temporarily locked may be used. For example, it is possible to transmit a speed impulse to the piston via a shock applied to a rear face of the piston.

Likewise, the piston, which in the examples described is stopped near the end of the cylindrical cavity by the adiabatic compression of the gas contained in the cavity, which in this case constitutes an isolated physical system, can be stopped by any means on condition that the system is an isolated system in this immobilization phase of the piston. Such a stopping means is, for example, a spring resting against the end of the cavity toward which the piston is moved.

If necessary, a same vehicle can use several propulsion devices of the invention disposed so as to counteract drifts during the time in which the angular momenta are out of balance in the two possible directions of rotation of the cavities.

The propulsion device of the invention thus makes it possible to obtain a thrust on a body without ejecting any matter, an advantage that is particularly important in the case of space vehicles designed for long distance voyages requiring the acquisition of high speeds in order to limit the duration of said voyage.

It is clear that in order to function, the propulsion device 100 must be supplied with the energy required to produce the motion imparted to the vehicle.

The device can function using energy in electrical form alone, to power primarily the electromagnets and to a lesser extent all of the accessories required for the operation of the propulsion device.

On board an interstellar space vehicle, electrical energy is for example produced by a radioisotope generator, the technology of which is known, and the operating life of which is more than 20 years.

To give an example of the implementation of the propulsion device of the invention, it may be calculated that at constant acceleration the star Proxima Centauri (Alpha Centauri C) located at a distance of 270,000 astronomical units (4.22 light years) could be reached in 18 years with a constant acceleration of 0.265 m/s2 (ignoring the effects of general relativity), the speed reached on arrival therefore being c/2, i.e. half the speed of light.

In the hypothetical case of a space vehicle with a mass of a 300 kg such as a probe vehicle, the acceleration presumes the application of an average force of 79.5 N (the mass multiplied by the acceleration).

The force generated by the propulsion device being internal to the system formed by the space vehicle, it is applied to an object at a relative speed of zero with respect to said propulsion device. In this case, assuming the average force to be a constant, the average power continuously transmitted to the space vehicle for its acceleration is 10.5 W.

With a hypothetical output of the propulsion system of only 1%, taking into account the impulsive aspect of said propulsion system and the losses in the various mechanical and electrical components, it was established that 1 kW of onboard power is enough to complete the mission. A radioisotope generator having the capacity to produce such power is perfectly accessible with the current technologies.

Although particularly advantageous in the case of space vehicles, for which the propulsion device of the invention makes long and distant voyages accessible, the propulsion device can be adapted to any types of vehicles for which a thrust is sought without the need to eject matter so as to create a reaction force or to apply a force acting on the surrounding matter.

In particular, the propulsion device of the invention offers the advantage of improved output in the case of a vehicle propelled in a fluid, like an airplane for example.

This result stems from the fact that drag varies by the square of the speed and that, in a conventional propulsion system, the propulsive power required varies by the cube of that same speed. With the propulsion device of the invention, the propulsive power required varies only by the square of the speed, just like drag. A quick digital application shows that for an airplane flying at 800 km/h, the propulsive power required becomes, with the propulsion device of the invention, on the order of one thousandth of what is required with the known propulsion systems.

1-13. (canceled)

14. A propulsion device for exerting a propulsive force on a vehicle by momentum exchange, comprising:
at least one sealed cavity comprising one or more cylindrical parts;
at least one piston of non-zero mass, inside said at least one sealed cavity containing a gas and movable within said one or more cylindrical parts in a sealed manner so that the gas located in a cylindrical part on one side of said at least one piston does not flow between said at least one piston and a wall of the cylindrical part opposite said at least one piston; and
wherein a momentum is obtained by a movement of said at least one piston, an acceleration of said at least one piston produced by a force acting on a structure of the vehicle, and a braking produced in isolation inside the propulsion device, without any force being applied to the vehicle, by a device that absorbs a kinetic energy of said at least one piston disposed in said at least one sealed cavity so as to brake said at least one piston in isolation inside the propulsion device, the braking of said at least one piston resulting from a compression of the gas between a face of said at least one piston and an end of said at least one sealed cavity inside which said at least one piston is moved.

15. Propulsion device according to claim 14, wherein a cylindrical part of said at least one sealed cavity inside which said at least one piston moves has a first orientation of a longitudinal axis of the cylindrical part, corresponding to a direction of a desired propulsive force in response to an acceleration of said at least one piston from a reference position of said at least one sealed cavity, and has a second orientation, different from the first orientation, in response to said at least one piston returning to the reference position of said at least one sealed cavity.

16. Propulsion device according to claim 15, wherein said at least one piston compresses the gas contained in a cylindrical part of said at least one sealed cavity between said at least one piston and an end of said cylindrical part in response to the acceleration of said at least one piston from the reference position of said at least one sealed cavity, and wherein said at least one piston is returned to the reference position of said at least one sealed cavity in response to a pressure of the compressed gas in said cylindrical part of said at least one sealed cavity.

17. Propulsion device according to claim 16, wherein each cylindrical part of said at least one sealed cavity comprises at least one piston lock configured to keep said at least one piston immobile in response to compression of the gas in said each cylindrical part.

18. Propulsion device according to claim 15, further comprising at least one electromagnet to accelerate said at least one piston made of a magnetic material and located at least temporarily near one end of the cylindrical part of said at least one sealed cavity inside which a core of said at least one piston is accelerated from the reference position of said at least one sealed cavity in which said at least one piston is movable,

19. Propulsion device according to claim 18, further comprising one or more intermediate electromagnets between the reference position and said at least one electromagnet.

20. Propulsion device according to claim 15, wherein said at least one sealed cavity is a cross-shaped cavity formed by two elementary cylindrical cavities with longitudinal axes oriented at right angles to form a cross comprising four cylindrical parts forming branches of the cross, an intersection of the two elementary cylindrical cavities determines the reference point of the cross-shaped cavity; and further comprising a rotational drive system to drive the cross-shaped cavity in rotation in a plane of the cross and around an axis passing through a center of the cross, to rotate the cross-shaped cavity by a 90-degree angle after the acceleration of said at least one piston from the reference position of the cross-shaped cavity in which said at least one piston is movable to produce the momentum and before returning said at least one piston to the reference position of the cross-shaped cavity.

21. Propulsion device according to claim 20, further comprising at least two cross-shaped cavities disposed relative to each other to be driven in rotation separately, and wherein the rotational drive system drives said at least two cross-shaped cavities in rotation in opposite directions and in synchronized manner to minimize an angular momentum resulting from rotational movements of said at least two cross-shaped cavities.

22. Propulsion device according to claim 15, wherein said at least one sealed cavity is a cylindrical cavity; wherein said at least one piston determines in the cylindrical cavity a substantially empty volume between said at least one piston and a first end of the cylindrical cavity corresponding to the reference position of the cylindrical cavity, and a volume containing the gas between said at least one piston and a second end of the cylindrical cavity; and further comprising a rotational drive system to rotate the cylindrical cavity by a 180-degree angle to reverse an orientation of a longitudinal axis of the cylindrical cavity after the acceleration of said at least one piston from the reference position of the cylindrical cavity in which said at least one piston is movable to produce the momentum and before returning said at least one piston to the reference position of the cylindrical cavity.

23. Propulsion device according to claim 22, further comprising at least two cylindrical cavities rotatable separately in parallel planes; and a rotational drive system for each cylindrical cavity such that said each cylindrical cavity is rotatable by a 180-degree angle in opposite directions and in synchronized manner to minimize an angular momentum resulting from rotational movements of said at least two cylindrical cavities.

24. Propulsion device according to claim 21, wherein the rotational drive system is configured to drive said at least two cross-shaped cavities in rotation in both directions of rotation around an axis of rotation of each cross-shaped cavity.

25. Propulsion device according to claim 15, further comprising a flywheel to totally or partially compensate a moment of inertia generated by changes in the orientation of one or more cylindrical parts of said at least one sealed cavity.

26. Propulsion device according to claim 15, further comprising:
a moment of inertia correction device comprising:
a sealed cylindrical cavity with a longitudinal axis containing a gas between a magnetic piston and an end of the sealed cylindrical cavity;
a heat exchanger to supply or extract from the gas contained in the sealed cylindrical cavity, energy in a form of heat;
an electromagnet positioned near the end of the sealed cylindrical cavity and disposed to exert an attractive force on the magnetic piston and to compress the gas contained in the sealed cylindrical cavity; and
wherein the moment of inertia correction device is attached to the structure of the vehicle with the propulsion device to generate a torque to correct moments of inertia induced by the propulsion device.

27. Vehicle comprising a propulsion device according to claim 14.
